(19) United States
(12) Patent Application Publication
(10) Pub. No.: US 2011/0022992 A1
(43) Pub. Date: Jan. 27, 2011

(54) METHOD FOR MODIFYING A REPRESENTATION BASED UPON A USER INSTRUCTION

(75) Inventors: Xiaoming Zhou, Eindhoven (NL); Paul Marcel Carl Lemmens, Eindhoven (NL); Alphons Antonius Maria Lambertus Bruekers, Eindhoven (NL); Andrew Alexander Tokmakoff, Eindhoven (NL); Evelijne Machteld Hart De Ruijter-Bekker, Eindhoven (NL); Serverius Petrus Paulus Pronk, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/933,920

(22) PCT Filed: Mar. 24, 2009
(86) PCT No.: PCT/IB09/51216

§ 371 Date: Sep. 22, 2010

(30) Foreign Application Priority Data
Mar. 31, 2008 (EP) 08153763.1

(51) Int. Cl. G06T 13/00; G06F 3/033

(52) U.S. Cl. 715/863; 345/473

(57) ABSTRACT

The invention relates to a method for modifying a representation based upon a user instruction and a system for producing a modified representation by said method. Conventional drawing systems, such as pen and paper and writing tablets, require a reasonable degree of drawing skill which not all users possess. Additionally, these conventional systems produce static drawings. The method of the invention comprises receiving a representation from a first user, associating the representation with an input object classification, receiving an instruction from a second user, associating the instruction with an animation classification, determining a modification of the representation using the input object classification and the animation classification, and modifying the representation using the modification. When the first user provides a representation of something, for example a character in a story, it is identified to a certain degree by associating it with an object classification. In other words, the best possible match is determined. As the second user imagines a story involving the representation, dynamic elements of the story are exhibited in one or more communication forms such as writing, speech, gestures, facial expressions. By deriving an instruction from these signals, the representation may be modified, or animated, to illustrate the dynamic element in the story. This improves the feedback to the users, and increases the enjoyment of the users.

### FIELD OF THE INVENTION

The invention relates to a method for modifying a representation based upon a user instruction, a computer program comprising program code means for performing all the steps of the method, and a computer program product comprising program code means stored on a computer readable medium for performing the method

The invention also relates to a system for producing a modified representation.

### BACKGROUND OF THE INVENTION

Many different types of drawing systems are available, ranging from the simple pen and paper to drawing tablets connected to some form of computing device. In general, the user makes a series of manual movements with a suitable drawing implement to create lines on a suitable receiving surface. Drawing on paper means that it is difficult to erase and change things.

Drawing using a computing device may allow changes to be made, but this is typically used in the business setting where drawing is required for commercial purposes. These electronic drawings may then be input into a computing environment where they may be manipulated as desired, but the operations and functionality are often commercially-driven.

Drawing for entertainment purposes is done mostly by children. The available drawing systems, whether pen and paper or electronic tablets, generally only allow the user to build up the drawing by addition—as long as the drawing is not finished, it may progress further. Once a drawing is completed, it cannot easily be modified. Conventionally, the user either has to delete one or more contours of the drawing and re-draw them, or start again with a blank page. Re-drawing after erasing one or more contours requires a reasonable degree of drawing skill which not all users possess.

Although children may enjoy using electronic drawing tablets, they are not designed with children in mind. The user interfaces may be very complicated, and a child does not possess the fine mechanical skills required to use these electronic devices successfully. Additionally, many of these devices are not robust enough for use by a child.

An additional problem, particularly in relation to children, is the static nature of these drawing systems. When drawing, children often make up stories and narrate them while drawing. A story is dynamic, so the overlap between what is being told and what is being drawn is limited to static elements, such as basic appearance and basic structure of the objects and characters.

### SUMMARY OF THE INVENTION

It is an object of the invention to provide a method for modifying a representation based upon a user instruction.

According to a first aspect of the invention the object is achieved with the method comprising receiving a representation from a first user, associating the representation with an input object classification, receiving an instruction from a second user, associating the instruction with an animation classification, determining a modification of the representation using the input object classification and the animation classification, and modifying the representation using the modification.

According to a further aspect of the invention, a method is provided wherein the instruction is derived from sounds, writing, movement or gestures of the second user.

When the first user provides a representation of something, for example a character in a story, it is identified to a certain degree by associating it with an object classification. In other words, the best possible match is determined. As the second user imagines a story involving the representation, dynamic elements of the story are exhibited in one or more communication forms such as movement, writing, sounds, speech, gestures, facial gestures, or facial expressions. By deriving an instruction from these signals from the second user, the representation may be modified, or animated, to illustrate the dynamic element in the story. This improves the feedback to the first and second users, and increases the enjoyment of the first and second users.

A further benefit is an increase in the lifetime of the device used to input the representation—by using derived instructions from the different forms, it is not necessary to continually use a single representation input as often as in known devices, such as touch-screens and writing tablets which are prone to wear and tear.

According to an aspect of the invention, a method is provided wherein the animation classification comprises an emotional classification. Modifying a representation to reflect emotions is particularly difficult in a static system because it would require, for example, repeated erasing and drawing of the mouth contours for a particular character. However, displaying emotion is often more subtle than simply the appearance of part of a representation, such as the mouth, so the method of the invention allows a more extensive and reproducible feedback to the first and second users of the desired emotion. In the case of children, the addition of emotions to their drawings greatly increases their enjoyment.

According to a further aspect of the invention, a system is provided for producing a modified representation comprising a first input for receiving the representation from a first user; a first classifier for associating the representation with an input object classification; a second input for receiving an instruction from a second user; a second classifier for associating the instruction with an animation classification; a selector for determining a modification of the representation using the input object classification and the animation classification; a modifier for modifying the representation using the modification, and an output device for outputting the modified representation.

According to another aspect of the invention, a system is provided wherein the first user and the second user are the same user, and the system is configured to receive the representation and to receive the instruction from said user.

### BRIEF DESCRIPTION OF THE DRAWINGS

These and other aspects of the invention are apparent from and will be elucidated with reference to the embodiments described hereinafter.

In the drawings:

FIG. 1 shows the basic method for modifying a representation based upon a user instruction according to the invention,

FIG. 2 depicts a schematic diagram of a system for carrying out the method according to the invention,

FIG. 3 shows an embodiment of the system of the invention,

FIG. 4 depicts a schematic diagram of the first classifier of FIG. 3,

FIG. 5 shows a schematic diagram of the second classifier of FIG. 3,

FIG. 6 depicts a schematic diagram of the selector of FIG. 3, and

FIG. 7 depicts an example of emotion recognition using voice analysis.

The figures are purely diagrammatic and not drawn to scale. Particularly for clarity, some dimensions are exaggerated strongly. Similar components in the figures are denoted by the same reference numerals as much as possible.

### DETAILED DESCRIPTION OF THE PREFERRED EMBODIMENTS

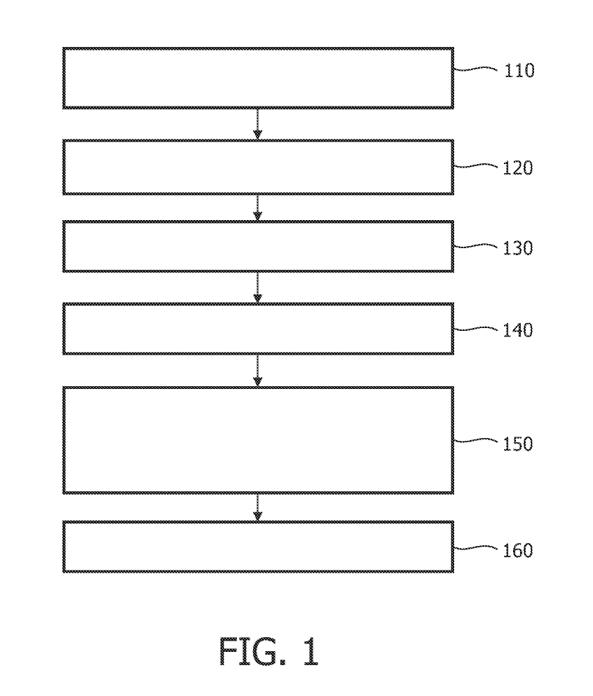

FIG. 1 shows the basic method for modifying a representation based upon a user instruction according to the invention.

The representation is received (110) from the first user. This representation forms the basis for the animation, and represents a choice by the first user of the starting point. The representation may be entered using any suitable means, such as by digitizing a pen and paper drawing, directly using a writing tablet, selecting from a library of starting representations, taking a photograph of an object, or making a snapshot of an object displayed on a computing device.

It may be advantageous to output the representation to the first user in some way immediately after it has been received.

The representation is associated (120) with an input object classification. Note that object is used in its widest sense to encompass both inanimate (for example, vases, tables, cars) and animate (for example, people, cartoon characters, animals, insects) objects. The invention simplifies the modification process by identifying the inputted representation as an object classification. Identification may be performed to a greater or lesser degree depending upon the capabilities and requirements of the other steps, and other trade-offs such as computing power, speed, memory requirements, programming capacity etc. when it is implemented by a computing device. For example, if the representation depicts a pig, the object classification may be defined to associate it with different degrees of identity, such as an animal, mammal, farmyard animal, pig, even a particular breed of pig.

Association of the representation with an object classification may be performed using any suitable method known to the person skilled in the art. For example, it may be based upon an appropriate model of analogy and similarity.

Systems are known in the art for letting users interact with computers by drawing naturally and which provide for recognition of a representation inputted as a sketch. Such systems showing current possibilities for sketch recognition are described in the paper, “Magic Paper: Sketch-Understanding Research,” Computer, vol. 40, no. 9, pp. 34-41, September, 2007, by Randall Davis of MIT. One of the examples is “Assist” (A Shrewd Sketch Interpretation and Simulation Tool) used to sketch simple 2D physical devices and then watch them behave. “Assist” understands the raw sketch in the sense that it interprets the ink the same way we do. It hands this interpretation to a physics simulator, which animates the device, giving the user the experience of drawing on intelligent paper.

Processing of the input representation, for example, reinterpreting the raw data supplied by the user as primitive shapes—lines and arcs, may be performed when the input representation is received, or during the association with the object classification. Finding primitive's based upon the data's temporal character to indicate direction or curvature and speed, may be used to assist in the association task.

As an alternative after association (120), the object classification may replace the representation during the subsequent steps of selection (150) and modification (160). The object classification would then represent an idealized version of the representation entered.

A representation somewhere between the original representation inputted and the idealized representation may also be used for the subsequent steps of selection (150) and modification (160). In this case, it would appear to the first user that the inputted representation is “tidied-up” to some degree. This may simplify the modification (160) of the representation by the selected animation (150).

An instruction is received (130) from a second user. This may be given in any form to represent a conscious wish, for example “the pig walks”, or it may reflect something derived from a communication means employed by the second user, such as comments made by the second user during the narration of a story, for example “and that made the pig happy”. It may also be advantageous to provide direct input options, such as “walk”, “happy” which the second user may directly select using any conventional means, such as buttons or selectable icons.

The instruction is associated (140) with an animation classification. To permit a certain degree of flexibility, it is not necessary to have knowledge of the predetermined classifications and to only relay these specific instructions. For example, if the animation classification “walk” is available, it may be associated with any instruction which approximates walk, such as the spoken words “walking”, “strolling”, “ambling” etc. Various degrees of animation classification may be defined. For example, if the animation instruction is “run”, the animation classification may be defined to associate it with “run”, “fast walk”, “walk”, or “movement”.

Animation is used here in its broadest sense to not only describe movements, such as running, jumping, but also to describe the display of emotional characteristics, such as crying, laughing. Such an animation may comprise a visual component and an audio component. For example, if the animation is intended to display “sad”, then the visual component may be tears appearing in the eyes and the audio component may be the sound of crying. Where appropriate, the audio and visual component may be synchronized so that, for example, sounds appear to be made by an animated mouth—for example, if the animation is “happy”, then the audio component may be a happy song, and the visual component may comprise synchronized mouth movements. The visual component may be modified contours, such an upturned mouth when smiling, or a change in colour, such as red cheeks when embarrassed, or a combination of these.

If the animation depicts an emotion, various degrees of animation classification may also be defined. For example, if the animation instruction is “happy”, the animation classification may be defined to associate it with “amused”, “smiling”, “happy”, or “laughing”.

The modification of the representation using the input object classification and the animation classification is selected (150). The object classification and animation classification may be considered as parameters used to access a defined library of possible modifications. The modification accessed represents the appropriate animation for the representation entered, for example, a series of leg movements representing a pig walking to be used when the object classification is “pig”, and the animation classification is “walks”.

Using the modification to modify (160) the representation. The first user's representation is then animated according to the selected modification, i.e. in the way that he has directly influenced.

A further measure which may prove advantageous is a learning mode, so that the first user may define object classifications themselves and/or adapt the way in which the representation is processed, in a similar way to that which is generally known in the art for handwriting and speech recognition, to improve the accuracy of association. The first user may also be asked to specify what the representation is, or to confirm that the representation is correctly identified.

Such a learning system is described in “Efficient Learning of Qualitative Descriptions for Sketch Recognition, by A. Lovett, M. Dehghani and K. Forbus, 20th International Workshop on Qualitative Reasoning. Hanover, USA, 2006. The paper describes a method of recognizing objects in an open-domain sketching environment. The system builds generalizations of objects based upon previous sketches of those objects and uses those generalizations to classify new sketches. The approach chosen is to represent sketches qualitatively because qualitative information provides a level of description that abstracts away details that distract from classification, such as exact dimensions. Bayesian reasoning is used in the process of building up representations to deal with the inherent uncertainty in the perception problem. Qualitative representations are compared using the Structure Mapping Engine (SME), a computational model of analogy and similarity that is supported by psychological evidence from studies of perceptual similarity. The system produces generalizations based on the common structure found by SME in different sketches of the same object.

The SME is a computational model of analogy and simulation, and may also form the basis for associating the representation with an object classification (120) and/or associating the instruction with an animation classification (140).

Similarly a learning mode may also be provided for the animation classification to improve the accuracy of its association.

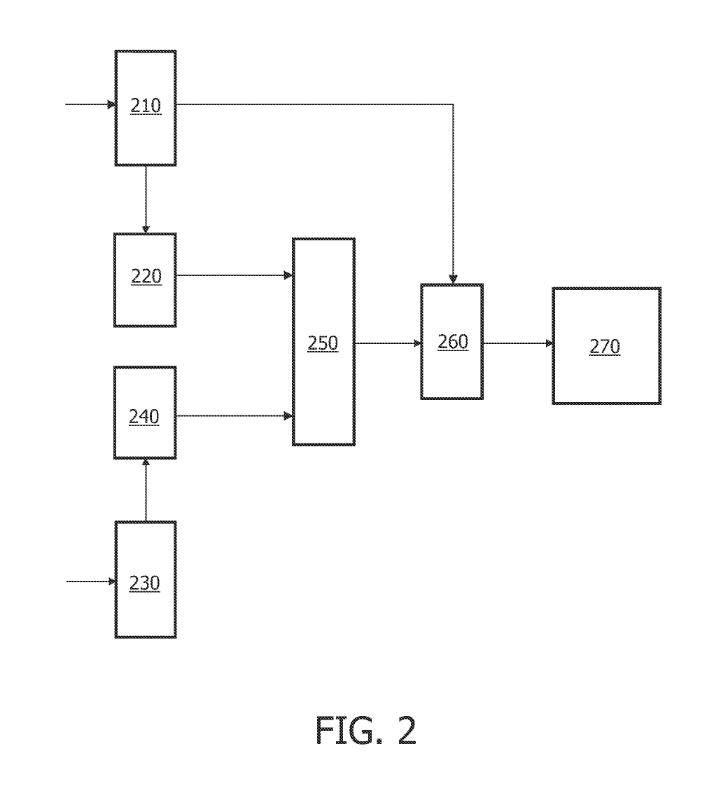

FIG. 2 depicts a schematic diagram of a system suitable for carrying out the method of FIG. 1.

The system comprises a first input (210) for receiving the representation from a first user and for outputting the representation in a suitable form to a first classifier (220). This may comprise any appropriate device suitable for inputting a representation in a desired electronic format. For example, it may comprise a device which converts the manual movements of the first user into digital form such as a drawing tablet or a touch-screen. It may be a digitizer, such as a scanner for digitizing images on paper or a camera for digitizing images. It may also be a network connection for receiving the representation in digital form from a storage device or location. The first input (210) also comprises a means to convert the representation into a form suitable for the first classifier (220).

When the system of FIG. 2 has received the representation from the first input (210), it may output it to the first user using the output device (270). In this way, the first user will immediately get feedback on the representation when it has been entered.

The system further comprises the first classifier (220) for associating the representation received from the first input (210) with an input object classification, and for outputting this object classification to the selector (250). The first classifier receives the representation and identifies it by associating it with an object classification. The first classifier (220) is configured and arranged to provide the input object classification to the selector (250) in an appropriate format.

One or more aspects of the representation may be used to assist in associating the representation with a classification. For example, any of the following may be used in isolation or in combination:

if the first input (210) is a drawing interface that detects the manual movement of the first user, the signals to the first classifier (220) may comprise how the representation is drawn, such as the sequence of strokes used, the size, speed and pressure;

what the representation looks like—the relationship of the strokes to each other;

what the first user relays by any detectable communication means during the inputting of the representation, as detected by an appropriate input.

Aspects which may be used when associating the representation with the input object classification are:

how the representation is defined—i.e. the set of geometric constraints the standardized representation must obey to be an instance of a particular object classification;

how the representation is drawn—i.e. the sequence of strokes used; and

what the representation looks like—i.e. the traditional concept of image identification.

One of the problems with generating an object classification from a representation is the freedom available to the first user to input partial representations, such as only the head of a pig, or different views, such as from the front, from the side, from above.

It may be advantageous to employ other interfaces with the first user such as sound, gesture or movement detection to increase the amount of information available to the processor in determining what the first user intends the representation to be. This is described below in relation to the possibilities for the second input (230). By monitoring the communication means such as sounds, speech, gestures, facial gestures, facial expressions and/or movement during the making and inputting of the representation, it is expected that additional clues will be provided. In the case of speech, these may be identified by an appropriate second input (230) and supplied to the first classifier (220).

It may even be advantageous to derive an instruction from these communications means which can be used as the sole means to associate the representation with an input object classification. The skilled person will realize that a combination of both these methods may also be employed, possibly with a weighting attached to the instruction and the representation.

Note that the word speech is used to describe every verbal utterance, not just words but also noises. For example, if the first user were to make the sound of a pig grunting, this may be used to help in associating the representation with an object classification.

If the first and second user are at the same physical location, each user may be provided with dedicated or shared inputs, similar to those described below for the second input (230). If the inputs are shared, the system may further comprise a conventional voice recognition system so that a distinction may be made between the first and second user inputs.

Alternatively, it may be advantageous to output (270) the representation as entered using the first input (210) only when the first classifier (220) has associated it with an object classification. This gives the first user confirmation that the step of association (120) has been completed successfully.

A second input (230) is provided for receiving an instruction from a second user and for outputting the instruction in a suitable form to the second classifier (240). This may comprise any appropriate device suitable for inputting an instruction, so that the second user may directly or indirectly instruct the system to modify the representation in a particular way. Second user's may give instructions, or cues, by many communication means, such as movement, writing, sounds, speech, gestures, facial gestures, facial expressions, or direct selection. The second input (230) comprises a suitable device for detecting a means of communication, such as a microphone, a camera or buttons with icons, means for deriving instructions from these inputs, and means to output the instructions into a form suitable for the second classifier (240).

It may also be advantageous to provide a plurality of second inputs (230) for a plurality of second users for a form of collaborative drawing. The system may then be modified to further comprise a means for analyzing and weighting the different inputs, and consequently determining what the dominant animation instruction is. This task may be simplified if all the inputs are restricted in deriving animation instructions of a particular type, for example limited to emotions. If required, conventional voice identification may also be used to give more weight to certain second users.

If animation instructions are to be derived from sounds or speech detected by a second input (220), several aspects may be used. For example, any of the following may be used in isolation or in combination:

recognition of trigger words contained within speech, such as “run”, “sad”, “happy”. Techniques to do this are known in the art, for example Windows Vista from Microsoft features Windows Speech Recognition;

pitch analysis of the second user's voice may be used to detect emotional state of the speaker, and

grammatical analysis may be used to filter out possible animation instructions which are not related to the input representation. For example, if the first user inputs the representation of a pig, but during narration of the story the second user mentions that the pig is scared because a dog is running towards it, it is important to only relay the animation instruction “scared”, and not “running”.

Speech recognition currently available from Microsoft is flexible—it allows a user to dictate documents and emails in mainstream applications, use voice commands to start and switch between applications, control the operating system, and even fill out forms on the Web. Windows Speech Recognition is built using the latest Microsoft speech technologies. It provides the following functions which may be utilized by the second input (230) and second classifier (240) to improve the ease of use:

Commanding: “Say what you see” commands allow natural control of applications and complete tasks, such as formatting and saving documents; opening and switching between applications; and opening, copying, and deleting files. You may even browse the Internet by saying the names of links. This requires the software to extract a context from the speech, so the same techniques may be used to apply the grammatical analysis to filter out unwanted animation instructions and/or to identify the animation instructions;

Disambiguation: Easily resolve ambiguous situations with a user interface for clarification. When a user says a command that may be interpreted in multiple ways, the system clarifies what was intended. Such an option may be added to a system according to the invention to clarify whether the correct associations have been made;

Interactive tutorial: The Interactive speech recognition tutorial teaches how to use Windows Vista Speech Recognition and teaches the recognition system what a user's voice sounds like; and

Personalization (adaptation): Ongoing adaptation to both speaking style and accent continually improves speech recognition accuracy.

Pitch analysis recognition: techniques to do this are known in the art, one example being described in European patent application EP 1 326 445. This application discloses a communication unit which carries out voice communication, and a character background selection input unit which selects a CG character corresponding to a communication partner. A voice input unit acquires voice. A voice analyzing unit analyzes the voice, and an emotion presuming unit presumes an emotion based on the result of the voice analysis. A lips motion control unit, a body motion control unit and an expression control unit send control information to a 3-D image drawing unit to generate an image, and a display unit displays the image.

Implementing this pitch analysis recognition in the system of FIG. 2, the second input (230) comprises a voice analyzing unit for analyzing a voice, and an emotion presuming unit for presuming an emotion based on the result of the voice analysis. The modifier 260 comprises a lips motion control unit, a body motion control unit and an expression control unit. The modifier (260) also comprises an image drawing unit to receive control information from the control units. The output device (270) displays the image. The voice analyzing unit analyzes the intensity or the phoneme, or both of the sent voice data. In human language, a phoneme is the smallest structural unit that distinguishes meaning Phonemes are not the physical segments themselves, but, in theoretical terms, cognitive abstractions of them.

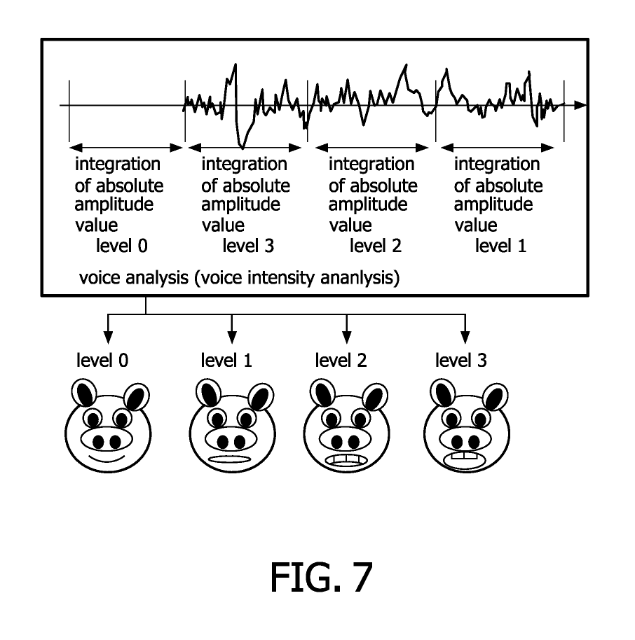

The voice intensity is analyzed in the manner that the absolute value of the voice data amplitude for a predetermined time period (such as a display rate time) is integrated (the sampling values are added) is integrated as shown in FIG. 7 and the level of the integrated value, is determined based upon a predetermined value for that period. The phoneme is analyzed in the manner that the processing for the normal voice recognition is performed and the phonemes are classified into “n”, “a”, “i”, “u”, “e” or “o”, or the ratio of each phoneme is outputted. Basically, a template obtained by normalizing the voice data of the phonemes “n”, “a”, “i”, “u”, “e” or “o” which are statistically collected is matched with the input voice data which is resolved into phonemes and normalized, the most matching data is selected, or the ratio of matching level is outputted. As for the matching level, the data with the minimum distance measured by an appropriately predefined distance function (such as Euclid distance, Hilbert distance and Maharanobis distance) is selected, or the value is calculated as the ratio by dividing each distance by the total of the measured distances of all the phonemes “n”, “a”, “i”, “u”, “e” and “o”. These voice analysis results are sent to the emotion presuming unit.

The emotion presuming unit stores the voice analysis result sent from the voice analyzing unit for a predetermined time period in advance, and presumes the emotion state of a user based on the stored result. For example, the emotion types are classified into “normal”, “laughing”, “angry”, “weeping” and “worried”.

As for the voice intensity level, the emotion presuming unit holds the level patterns for a certain time period as templates for each emotion. Assuming that the certain time period corresponds to 3 times of voice analyses, the templates show that “level 2, level 2, level 2” is “normal”, “level 3, level 2, level 3” is “laughing”, “level 3, level 3, level 3” is “angry”, “level 1, level 2, level 1” is “weeping” and “level 0, level 1, level 0” is “worried”.

For the stored 3-time analysis result against these templates, the sum of the absolute values of the level differences (Hilbert distance) or the sum of the squares of the level differences (Euclid distance) is calculated so that the most approximate one is determined to be the emotion state at that time. Or, the emotion state is calculated with a ratio obtained by dividing the distance for each emotion by the sum of the distances for all the emotions.

The task of grammatical analysis to derive animation instructions may be simplified by a user using special phrasings or pauses within a sentence. These pauses should separate animation instructions, degree of animation instruction and object classifications.

For example, the sentence “There is a pig called Bill, he is very happy because today is his birthday” should in this case be pronounced as

“There is a . . . pig . . . called Bill, he is . . . very . . . happy . . . because today is his birthday.”

Similar, for the sentence “The dog is very sad when he finds he did not pass the exam” would in that case be pronounced as

“The . . . dog . . . is . . . very . . . sad . . . when he finds he did not pass the exam”

Either additionally, or alternatively, the second classifier (240) may be provided with inputs to derive the animation instruction from movement, writing, gestures or facial expressions, or any combination thereof. In other words, multiple techniques may be used, such as handwriting recognition, gesture recognition and facial expression recognition.

Gesture and movement recognition: techniques to do this are known in the art, One such technique is disclosed in “Demo: A Multimodal Learning Interface for Sketch, Speak and Point Creation of a Schedule Chart,” Proc. Int'l Conf. Multimodal Interfaces (ICMI), ACM Press, 2004, pp. 329-330. by E. Kaiser et al. This paper describes a system which tracks a two person scheduling meeting: one person standing at a touch sensitive whiteboard creating a Gantt chart, while another person looks on in view of a calibrated stereo camera. The stereo camera performs real-time, untethered, vision-based tracking of the onlooker's head, torso and limb movements, which in turn are routed to a 3D-gesture recognition agent. Using speech, 3D deictic gesture and 2D object de-referencing the system is able to track the onlooker's suggestion to move a specific milestone. The system also has a speech recognition agent capable of recognizing out-of-vocabulary (OOV) words as phonetic sequences. Thus when a user at the whiteboard speaks an OOV label name for a chart constituent while also writing it, the OOV speech is combined with letter sequences hypothesized by the handwriting recognizer to yield an orthography, pronunciation and semantics for the new label. These are then learned dynamically by the system and become immediately available for future recognition.

Facial gesture and facial expression recognition: techniques to do this are known in the art, such as the system described in “The Facereader: online facial expression recognition”, by M. J. den Uyl, H. van Kuilenburg; Proceedings of Measuring Behavior 2005; Wageningen, 30 Aug.-2 Sep. 2005. The paper describes the FaceReader system, which is able to describe facial expressions and other facial features online with a high degree of accuracy. The paper describes the possibilities of the system and the technology used to make it work. Using the system, emotional expressions may be recognized with an accuracy of 89% and it can also classify a number of other facial features.

The function of the second classifier (240) is to associate the instruction received from the second input (230) with an animation classification, and to output the animation classification to the selector (250). The second classifier (240) is configured and arranged to provide the animation classification to the selector (250) in an appropriate format.

If multiple inputs are used to the second classifier (240), the second classifier (240) may further comprise a means for analyzing and weighting the different inputs, and consequently determining what the dominant animation instruction is, and therefore what should be associated with an animation classification. This task may be simplified if all the inputs are restricted in deriving animation instructions of a particular type, for example limited to emotions.

Even when a single input is used, the second classifier (240) may still analyze and weigh different animation instructions arriving at different times. For example, to deal with inputs like “The . . . pig . . . felt . . . sad . . . in the morning, but in the afternoon he became . . . happy . . . again. He was so . . . happy . . . that he invited his friends to his home for a barbecue”, the animation instruction “happy” should be chosen. In practice, a user may pause for a number of milliseconds for those key words. Alternatively, if multiple emotion words are detected, the emotions depicted on the character may dynamically follow the storyline that is being told. This would depend upon the response time of the system—i.e. the time from the second user giving the animation instruction to the time for the animation to be output on an output device (270).

The system comprises the selector (250) for determining a modification of the representation using the input object classification, received from the first classifier (220), and from the animation classification, received from the second classifier (240). The output of the selector (250) is the selected modification, which is provided to a modifier (260). The two input parameters are used to decide how the representation will be modified by the modifier (260), and the selector (250) provides the modifier (260) with appropriate instructions in a suitable format.

The modifier (260) is provided in the system for modifying the representation using the modification. The modifier (260) receives the representation from the first input (210) and further receives the modification from the selector (250). The modifier (260) is connected to the output device (270) which outputs the representation so that it may be perceived by the first and/or second user. The modifier (260) applies the modification to the representation, and as it does so, the perception by the first and/or second user of the representation on the output device (270) is also modified. The modifier (260) may be configured and arrange to directly provide the output device (270) with the representation received from the first input device (210), i.e. without, or prior to, providing the output device (270) with the modified representation. For example, after the first user has inputted a drawing and before an animation instruction has been derived, the drawing may be displayed on the output device. Subsequently, when an instruction is derived from the second input (230), the first and/or second user will then see the drawing animated.

The system also comprises the output device (270) for receiving the signals from the modifier (260) and for outputting the modified representation so that the user may perceive it. It may comprise, for example, an audio output and a visual output.

An additional advantage for a user of the system is that a high-level of drawing skill is not required. Using a basic representation and giving instruction means that a user who is not a great artist may still use the system, and get enjoyment from using it.

By receiving inputs from a first and second user, collaborative drawing is possible. The first and second users may be present in the same physical location of different physical locations.

If the first and second users are present in different physical locations, the method may be modified so that a first representation is received (110) from a first user and a first instruction is received (130) from a second user, and a second representation is received from the second user and a second instruction is received from the first user.

In the case of collaborative drawing where the first and second users are in the same physical location, the output device (270) may be shared or each user may be provided with a separate display. Where the first and second users are in different physical locations, both users or only one user may be provided with a display.

It may be advantageous to modify the method so that the first user and the second user are the same user. This may reduce the number of inputs and outputs required, and may increase the accuracy of the association steps as fewer permutations may be expected. In this manner the invention can be used to prove an interactive drawing environment for a single user.

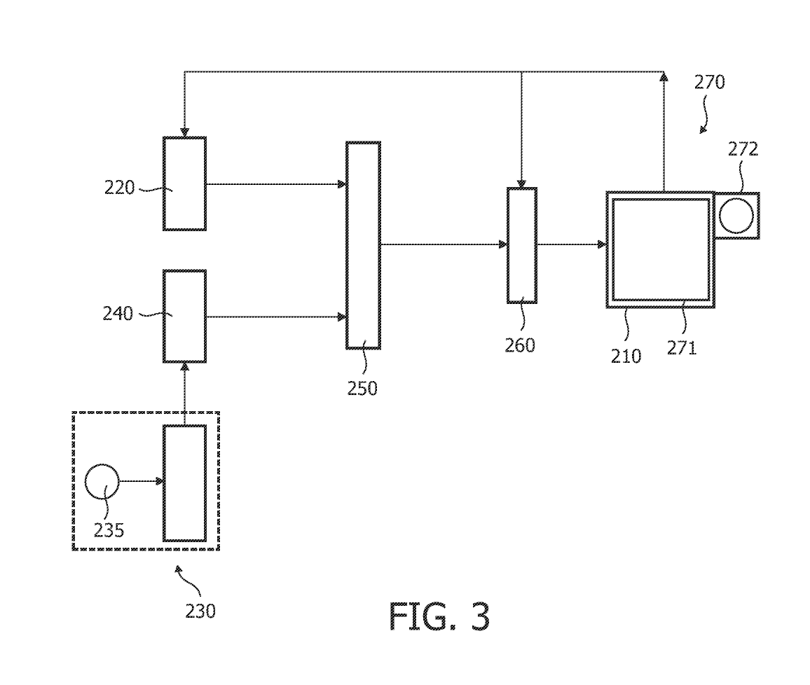

FIG. 3 depicts an embodiment of the system of the invention, which would be suitable for a child. The system of FIG. 3 is the same as the system of FIG. 2, except for the additional aspects described below. As will be apparent to the skilled person, many of these additions may also be utilized in other embodiments of the system of FIG. 2.

In the description of this embodiment, the first user and the second user are the same user, and is simply referred to as a/the user.

By designing the system specifically for a child, the complexity level of the system may be reduced. For example, the number of possible object classifications and/or animation classifications may be reduced to approach the vocabulary and experience of a child. This may be done in ways similar to those employed for other information content such as books or educational video, by:
restricting the possible input object classifications to an approximate location, such as “on the farm”, “around the house”, “at school”; and/or

restricting the animation classifications to a theme, such as “cars”, “animals”, “emotions”.

It may even be advantageous to make the complexity variable so that the possibilities may be tuned to the child's abilities and age.

The output device (270) comprises a visual display device (271), such an LCD monitor and an optional audio reproduction device (272), such a loudspeaker. To simplify the system for the user, the first input (210) for the user representation may be integrated into the same unit as is used for the output. This may be done, for example, using a writing tablet connected to a computing device, or a computer monitor provided with a touch screen.

The second input (230) comprises a microphone (235) for detecting sounds, in particular speech made by the child as instructions are given or as a story is narrated. The microphone (235) may also be integrated into the output device (270).

During operation, the child selects the starting point by drawing a representation of an object using the first input (210). After indicating completion of the drawing, such as by pressing an appropriate button or waiting a certain length of time, the first classifier (220) will associate the representation with an object classification.

Alternatively, the first classifier (220) may continuously attempt to associate the representation with an object classification. This has the advantage of a faster and more natural response to the user.

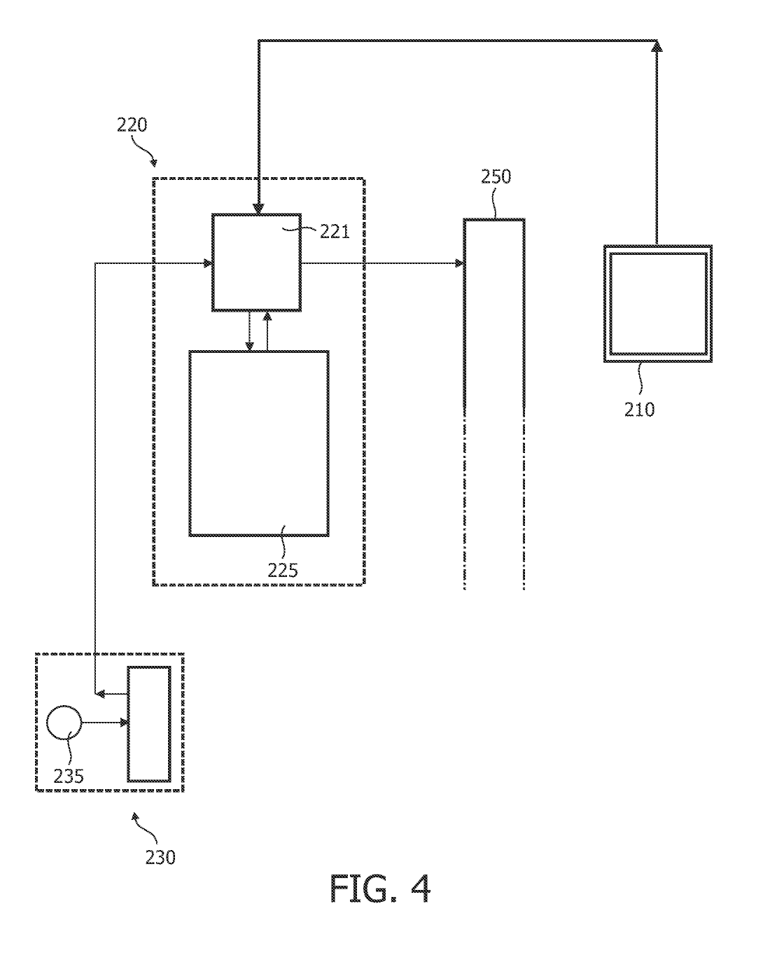

FIG. 4 depicts a schematic diagram of the first classifier (220) of FIG. 3, which comprises a first processor (221) and an object classification database (225). When a representation is input using the first input (210), the raw data needs to be translated into an object in some way. For example, when the user draws a pig, then the task of the first classifier (220) is to output the object classification “pig” to the selector (250). The task of the first processor (221) is to convert the signals provided by the first input (210) to a standardized object definition, which may be compared to the entries in the object classification database (225). When a match of the object is found in the database (225), the object classification is output to the selector (250).

Several aspects of the representation may be used by the first processor (221) to determine the standardized object definition. For example, any of the following may be used in isolation or in combination:

if the first input (210) is a drawing interface that detects the manual movement of the user, the signals to the first processor (221) may comprise how the representation is drawn, such as the sequence of strokes used, the size, speed and pressure;

what the representation looks like—the relationship of the strokes to each other;

sounds that the user makes during the inputting of the representation, as detected by the second input (230) comprising the microphone (235); and

what the user writes during inputting of the representation—handwriting analysis may be used to detect any relevant words.

After the system of FIG. 3 has determined the object classification, it may display the original representation as entered using the first input (210) on the visual display device (271). This gives the user a visual signal that association has been successful.

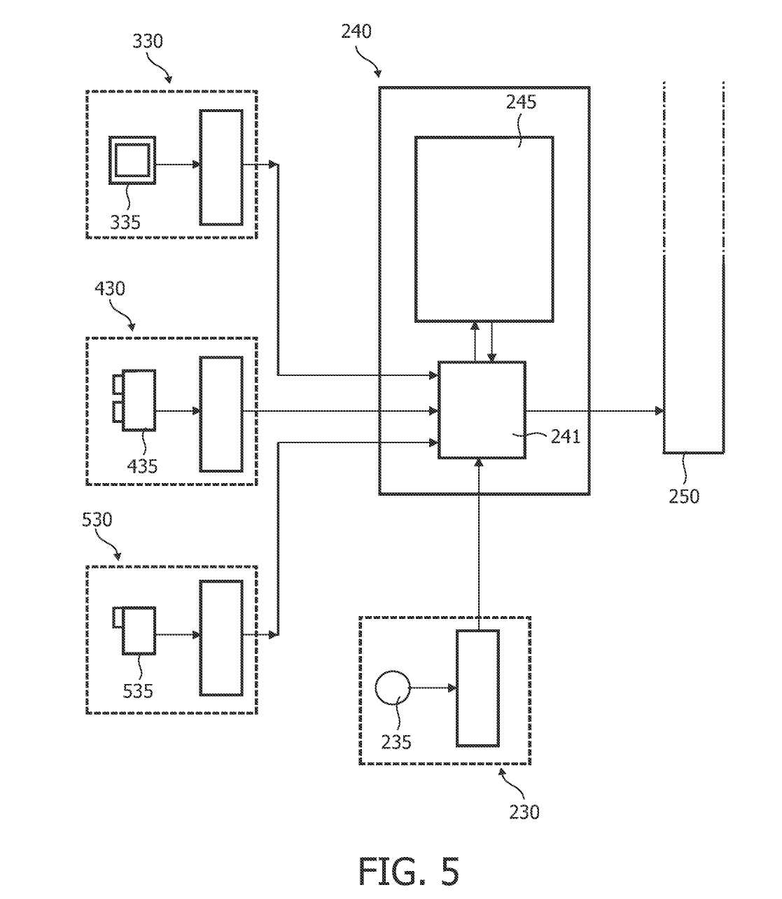

FIG. 5 depicts a schematic diagram of the second classifier (240) of FIG. 3, which comprises a second processor (241) and an animation classification database (245). When sounds such as speech are input using the second input (230), the animation cues within the speech need to be detected and translated into an animation in some way.

Emotional animations are particularly advantageous for children as this increases their connection with the representations displayed, and keeps them interested in using the system longer. This improves memory retention and enhances the learning experience.

For example, when the user says “run”, then the task of the second classifier (240) is to output the animation classification “run” to the selector (250). When the user says “sad”, the task of the second classifier (240) is to output the animation classification “sad” to the selector (250).

The task of the second processor (241) is to convert the sounds provided by the second input (230) to a standardized animation definition, which may be compared to the entries in the animation classification database (245). When a match of the animation is found in the database (245), the animation classification is output to the selector (250).

Either additionally, or alternatively, appropriate inputs may be provided to derive the instruction from movement, writing, gestures, facial gestures or facial expressions, or any combination thereof:

handwriting or hand-movement recognition. The signals may be provided using a third input (330) comprising a digital writing implement (335), which for convenience may be combined with the first input (210);

movement or gesture recognition. By using a first image detection device (435), such as a stereo camera, comprised in a fourth input (430), instructions may be derived from the movements of the user's limbs and physical posture.

facial expression, facial movement or facial gesture recognition. By using a second image detection device (535), such as a camera, comprised in a fifth input (530), instructions may be derived from the movements of the user's facial features. This is particularly useful when an animation instruction corresponding to an emotion is desired.

When the system of FIG. 3 has determined the animation classification, it is passed to the selector (250).

The animation classification may comprise an action, such as “run”, and a degree, such as “fast” or “slow”. For example, if the animation classification is an emotion, such as “sad”, then the degree may be “slightly” or “very”. If this is desired, the second classifier (220) would have to be modified to determine this from the available inputs (230, 330, 430, 530). In practice, the degree may be encoded as a number, such as −5 to +5, where 0 would be the neutral or default level, +5 would be “very”, or “very fast”, and −5 would be “slightly” or “very slow”. If the second classifier (220) was unable to determine this degree, a default value of 0 may be used.

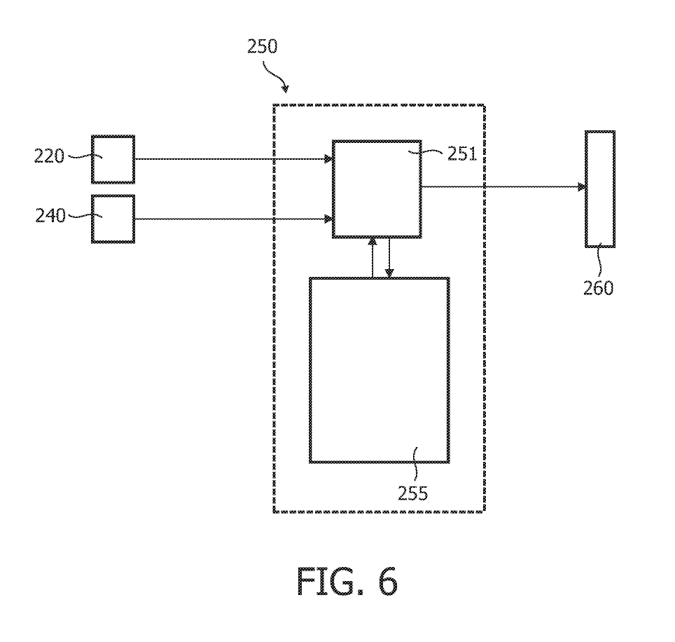

FIG. 6 depicts a schematic diagram of the selector (250) of FIG. 3, which comprises a third processor (251) and an animation database (255).

After receiving the input object classification from the first classifier (220) and the animation classification from the second classifier (240), the third processor (251) will access the animation database (255) to obtain the appropriate animation. This appropriate animation will be passed to the modifier (260), where the user representation is modified based upon the appropriate animation, and the animated representation will be displayed to the user using the display device (270). For example, if the input object classification is “pig”, and the animation classification is “happy”, then the third processor (251) will access the appropriate animation for a “happy pig”.

As mentioned above, it may be advantageous to reduce the complexity of the system by restricting the available input object classifications and/or the animation classifications. These parameters directly influence the complexity and size of the animation database.

It may also be advantageous to limit the animations to one or more portions of the representation, such as the voice, gestures, facial expressions, gait, hairstyle, clothing, posture, leg position, arm position etc. This may also reduce the complexity of the system. For example, an emotion, such as “sad” may be restricted to:

only the face of the representation, or

just to the mouth, for example, the mouth becoming down-turned, or

to the eyes, for example, where tears appear.

If the appropriate animation is restricted to such a portion, then this would have to be communicated to the modifier (260), so that the modifier would know where to apply the animation.

Alternatively, the portion of the representation to be animated may be selectable by the user providing a certain animation instruction through the existing inputs (210, 230, 330, 430, 530), or by having a further input detection on the output device (270). For example, by touching or pointing at a portion of the representation, only the audio and visual component associated with that part of the representation are output. For example, pointing at the mouth, will result in singing. While pointing at the hands, the representation may applaud. Pointing at the eyes may make tears appear.

The simplest form of animation which would be suitable, would be similar in complexity to Internet “smileys”—basically mouth, eye and nose shapes.

The appropriate animation may be provided to the modifier (260) in any suitable format, such as frame-by-frame altering by erasing and/or addition. The animation may also take the form of instructions in a format recognized by the modifier, such as “shake”. In such a case, the modifier would know how to shake the representation, for example by repeatedly adding and erasing additional contours outside contours of the original representation.

Similarly, the animation may comprise a combination of instruction and animation—for example, to animate the representation walking, the animation may comprise one set of legs at +30 degrees, one set at −30 degrees, and the instruction to display these alternately. The time between the display of such an animation set may be fixed, related to the relevant animation classification such as “run” and “walk”, or the degree of animation classification such as “fast” or “slow”.

The animation may also comprise a stream of animation pieces and/or instructions for different portions of the representation. For example, if the representation has been associated with a dog, and the animation instruction has been associated with running, then the animation may comprise subsequent instructions to move the legs left and right, then move the head up and down, then move the tail up and down.

When the system of FIG. 3 has determined the appropriate animation, it is passed to the modifier (260). The modifier (260) receives the representation from the first input (210), applies the animation from the selector (250) to the representation, and passes it to the output device (270).

As the appropriate animation may only affect a portion of the representation, such as the legs, it may be advantageous to provide the modifier (260) with the facility to detect the appropriate portions of the representation. This task may be simplified by providing the modifier (260) with the input object classification generated by the first classifier (220) and providing means to determine the relevant portion of the representation.

The output device (270) receives the signals from the modifier, and produces the appropriate output for the user. The visual component of the representation is displayed on the video display (271), and any audio component is reproduced using the audio reproduction device (272).

It may be advantageous to allow the user to fill the animation database (255) themselves in either a learning (new animations) or an editing (modified animations) mode. In this way animations may be split or merged into new ones. This may also be done separately for the audio and visual components of an animation, so that, for example, the user may record a new audio component for an existing animation, or replace an existing audio component with a different one. Also the user may copy animations from one input object classification to another, for example the animation of a sad pig may be copied to that of a dog, to create an animation for a sad dog.

The system of FIG. 3 may be modified so that collaborative drawing is possible for a plurality of children. As described above in relation to FIGS. 1 and 2, this may require one or more inputs and outputs.

It should be noted that the above-mentioned embodiments illustrate rather than limit the invention, and that those skilled in the art will be able to design many alternative embodiments without departing from the scope of the appended claims. For example, the embodiments refer to a number of processors and databases, but the system of FIG. 2 may be operated using a single processor and a single combined database.

The methods of the invention may encoded as program code within one or more programs, such that the methods are performed when these programs are run on one or more computers. The program code may also be stored on a computer readable medium, and comprised in a computer program product.

The system of FIG. 2 may be a stand-alone dedicated unit, or it may be a PC provided with program code, or software, for executing the method of FIG. 1, or as a hardware add-on for a PC. It may be integrated into a portable electronic device, such as a PDA or mobile telephone.

It may also be incorporated into the system for virtually drawing on a physical surface described in International Application IB2007/053926 (PH007064). The system of FIG. 3 would be particularly advantageous because the system described in the application is also designed specifically for children.

The system of FIG. 2 may further comprise a proximity data reader, such as those used in RFID applications, which would allow the representation to be entered by bringing a data carrier close to a reader. Similarly a contact data reader such as USB device may also be used. The representations may then be supplied separately on an appropriate data carrier.

The skilled person would be able to modify the system of FIG. 2 to exchange data through a communications network, such as the internet. For example, on-line libraries of representations and appropriate animations may be made available for download into the system.

Similarly, the skilled person would also be able to modify the embodiments so that their functionality is distributed, allowing the first and second users to collaboratively draw in physically the same location or physically separated locations. One or more of the users may then be provided with one or more of the following devices: a first input (210), a second input (230) and an output device (230)

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements.

In the device claim enumerating several means, several of these means may be embodied by one and the same item of hardware. The mere fact that certain measures are recited in mutually different dependent claims does not indicate that a combination of these measures cannot be used to advantage.

In summary the invention relates to a method for modifying a representation based upon a user instruction and a system for producing a modified representation by said method. Conventional drawing systems, such as pen and paper and writing tablets, require a reasonable degree of drawing skill which not all users possess. Additionally, these conventional systems produce static drawings.

The method of the invention comprises receiving a representation from a first user, associating the representation with an input object classification, receiving an instruction from a second user, associating the instruction with an animation classification, determining a modification of the representation using the input object classification and the animation classification, and modifying the representation using the modification.

When the first user provides a representation of something, for example a character in a story, it is identified to a certain degree by associating it with an object classification. In other words, the best possible match is determined. As the second user imagines a story involving the representation, dynamic elements of the story are exhibited in one or more communication forms such as writing, speech, gestures, facial expressions. By deriving an instruction from these signals, the representation may be modified, or animated, to illustrate the dynamic element in the story. This improves the feedback to the users, and increases the enjoyment of the users.

1. A method for modifying a representation based upon a user instruction comprising:
receiving (110) the representation from a first user;
associating (120) the representation with an input object classification;
receiving (130) an instruction from a second user;
associating (140) the instruction with an animation classification;
selecting (150) a modification of the representation using the input object classification and the animation classification, and
modifying (160) the representation using the modification.

2. The method of claim 1, wherein the animation classification comprises an emotional classification.

3. The method of claim 1, wherein the first user and the second user are the same user.

4. The method of claim 1 wherein the method further comprises:
deriving a further instruction from a communication means of the first user selected from the group consisting of direct selection, movement, sounds, speech, writing, gestures, and any combination thereof, and
associating (120) the representation with an input object classification using the further instruction.

5. The method of claim 1, wherein the method further comprises:
deriving (135) the instruction from a communication means of the second user selected from the group consisting of direct selection, movement, sounds, speech, writing, gestures, and any combination thereof.

6. The method of claim 5, wherein the method further comprises:
deriving (135) the instruction from the facial gestures or facial expressions of the second user.

7. The method of claim 1, wherein the method further comprises:
deriving (115) the representation from a movement or gesture of the first user.

8. The method of claim 7, wherein the representation is derived (115) from manual movements of the first user.

9. The method of claim 1, wherein the representation comprises an audio and a visual component.

10. The method of claim 9, wherein the modification (160) is limited to the audio component or limited to the visual component of the representation.

11. The method of claim 1 wherein the modification (160) is limited to a portion of the representation.

12. A system for producing a modified representation comprising:
a first input (210) for receiving the representation from a first user;
a first classifier (220) for associating the representation with an input object classification;
a second input (230) for receiving an instruction from a second user;
a second classifier (240) for associating the instruction with an animation classification;
a selector (250) for determining a modification of the representation using the input object classification and the animation classification;
a modifier (260) for modifying the representation using the modification, and
an output device (270) for outputting the modified representation.

13. The system of claim 12, wherein the first user and the second user are the same user, and the system is configured to receive the representation and to receive the instruction from said user.

14. A computer program comprising program code means for performing all the steps of claim 1, when said program is run on a computer.

15. A computer program product comprising program code means stored on a computer readable medium for performing the method of claim 1, when said program code is run on a computer.
